(19) United States
(12) Patent Application Publication
(10) Pub. No.: US 2007/0181729 A1
(43) Pub. Date: Aug. 9, 2007

(54) RE-SPOOLING FISHING REEL

(76) Inventor: Donald Stephen Schuster, Rogers, MN (US)

Correspondence Address: Don Schuster, 13384 Fawn Trail, Rogers, MN, 55374, US

(21) Appl. No.: 11/566,085

(22) Filed: Dec. 1, 2006

Related U.S. Application Data
(60) Provisional application No. 60/743,007, filed on Dec. 2, 2005.

(51) Int. Cl. A01K 89/00

(52) U.S. Cl. 242/322

(57) ABSTRACT

A rod-free fishing reel is described that includes a rod-free spool assembly for holding fishing line and a winding mechanism. The winding mechanism re-spools that fishing line after it is pulled in by the fisherman. The present invention is particularly suited for rodless fishing such as ice fishing with rattle reels. The winding mechanism includes a spring to provide a rotary force that is sufficient to reel in a fishing line but not reel in a fish. Moreover, the rotary force will not interfere with the fisherman gripping the line and controlling setting the hook or reeling in the line hand over hand directly on the line intermediate the spool and the fishing hole. In an embodiment, the winding mechanism has a plurality of positions. In an embodiment, the winding mechanism includes a pawl and the spool includes a ratchet.

This application claims the benefit under 35 USC 119(e) and any other benefit of U.S. Provisional Application Ser. No. 60/743,007, filed Dec. 2, 2005, titled “RE-SPOOLING FISHING REEL”, which application is incorporated herein by reference.

### FIELD OF THE INVENTION

The present invention relates to a fishing reel, and, more particularly, to a rod-free-type reel or a rattle reel.

### BACKGROUND

In certain fishing environments, the fisherman uses a fishing set up that does not include a rod or a handle attached directly to the spool. Such handles are used to spin the spool to reel in the line and land a fish. In some fishing environments, such as ice fishing, the fisherman uses a rod free set up and pulls the line in hand over hand directly on the fishing line. The fisherman grips the line intermediate the fishing hole and the spool. The fisherman pulls in the line and the line piles on the ice, shanty floor, or ground. A pile of loose fishing line is generally not desirable as evidenced by the use of spools to hold fishing line. A pile of loose line may tangle and not be easily recoverable for later use. As a result, a fisherman may not be able to quickly get the line back in the water. Lost opportunities to catch fish may result from tangled line. Loose fishing line may further represent a danger to an inattentive fisherman. During the excitement of landing a fish or the disappointment of the one that got away, a fisherman may not have re-spooled the line. While uncommon, a fisherman may be entangled in or trip over the loose line. Many times a fisherman may be alone and if he falls he may be hurt. Moreover, the fisherman may be hooked as a result of a tangled line, for example, when attempting to untangle or re-spool the line. Accordingly, there is a need to provide a structure and method for re-spooling line while not interfering with a line in hand or hand over hand fishing experience.

### SUMMARY OF THE INVENTION

In an aspect, a fishing reel includes a spool for holding fishing line and a winding mechanism. The winding mechanism is selectably actuable to rotate the spool to re-spool the line. In an embodiment, the winding mechanism has a first position engaged with the spool for rotating the spool to re-spool loose fishing line, and a second position not engaged with the spool. In the second position, the winding mechanism has potential force, stores or is loaded with a force sufficient to rotate the spool. In an embodiment, the force is sufficient to wind the line onto the spool but insufficient to reel in a fish. In an embodiment, the winding mechanism includes a pawl to selectively engage the spool assembly. The spool assembly includes a ratchet to receive the pawl. Accordingly, the winding mechanism can rotate in a first direction relative to the spool. The winding mechanism when rotating in another direction engages the spool causing it to rotate with the winding mechanism. The pawl can be mounted to a housing. Winding mechanism includes a motive force structure to rotate the spool assembly. In an embodiment, the winding mechanism rotates with the spool assembly in the second position. In an embodiment, the motive force structure can be a coil spring. In an embodiment, the motive force structure can be a motor, e.g., an electric motor.

In an aspect, a rodless fishing reel system includes a support, an axle connected to the support, a spool on the axle, and a winding mechanism. In an embodiment, the winding mechanism is on the axle. The winding mechanism is selectably actuatable to rotate the spool. In an embodiment, the winding mechanism is rotatable relative to the axle and longitudinally movable along the axle. The winding mechanism has a rotatable position on the axle and is free from the spool. The winding mechanism has fixed, non-rotatable position on the axle. The winding mechanism has a further spool engaged position whereat the winding mechanism rotates the spool to re-spool the line.

The winding mechanism may include a motive force structure that is loadable in the rotatable position, stores force in the fixed position, and transmits force to the spool in the engaged position. In an embodiment, the winding mechanism includes a housing and a spring that has a first end fixed to the axle and a second end fixed to the housing. The spring may be a torsion spring.

In an embodiment, the axle includes a key that engages the housing to prevent rotation of the winding mechanism on the axle. In an embodiment. the spool and housing includes a pawl and ratchet combination. In an embodiment, the axle includes a fastener that holds the spool at a fixed longitudinal position. In an embodiment, the winding mechanism includes a motor to selectively rotate the spool. In an embodiment, the fishing reel system stores fishing line and supplies fishing line to a fishing hole free of other line holding devices. The support includes an attachment to at least one of a shanty, a tripod, and a ground/ice contacting base.

### BRIEF DESCRIPTION OF THE DRAWINGS

FIG. 1 is an exploded view of a fishing reel according to an embodiment of the present invention.

FIG. 2 is a view of a fishing reel in a first use position according to an embodiment of the present invention.

FIG. 3 is a view of a fishing reel in a second position according to an embodiment of the present invention.

FIG. 4 is a view of a fishing reel in a third use position according to an embodiment of the present invention.

FIG. 5 is a view of a fishing reel according to an embodiment of the present invention.

FIG. 6 is an exploded view of a fishing reel according to an embodiment of the present invention.

### DETAILED DESCRIPTION

In the following detailed description of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope and spirit of the present invention. Different instances of the word “embodiment” as used within the specification do not necessarily refer to the same embodiment, but they may. The following detailed description is, therefore, not to be taken in a limiting sense, and the scope of the present invention is defined only by the appended claims.

In the following description, numerous specific details are set forth to provide a thorough understanding of the invention. It is understood, however, that the invention may be practiced without these specific details. In other instances, well-known circuits, structures, and techniques have not been shown in detail in order not to obscure the invention.

In this document, the terms “a” or “an” are used, as is common in patent documents, to include one or more than one. In this document, the term “or” is used to refer to a nonexclusive or, unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

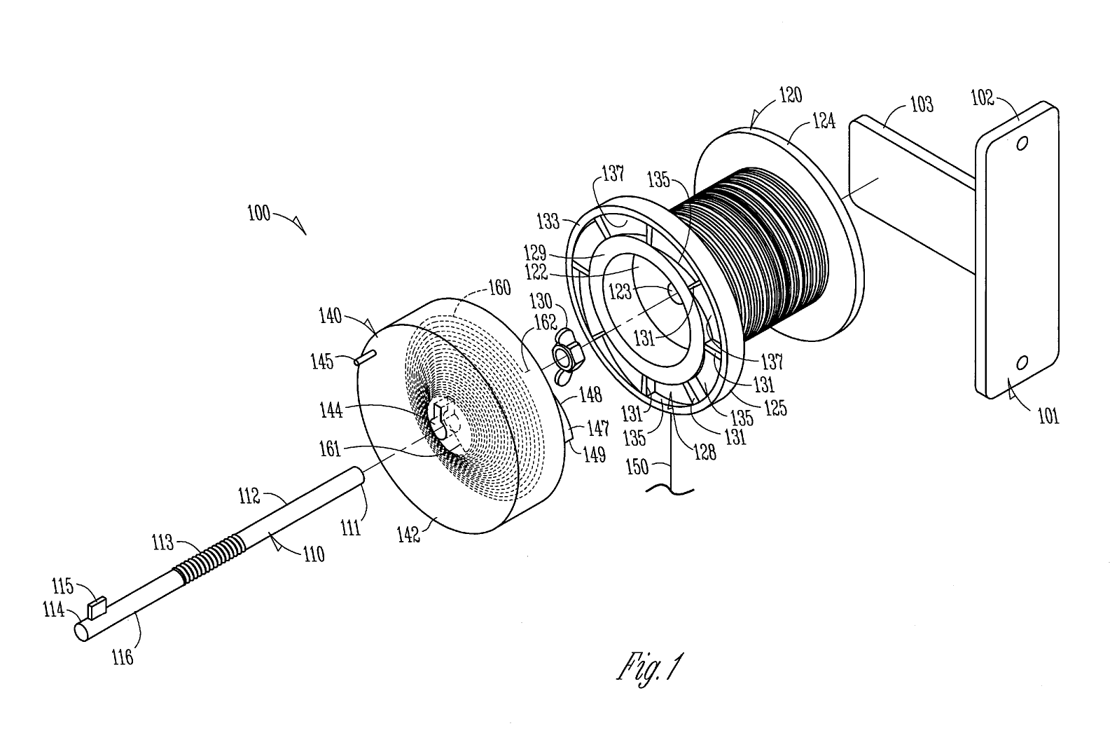

FIG. 1 shows a representation of a fishing reel assembly 100 that includes a support 101, an axle 110 connected to the support 101, a spool 120 rotatably mounted on the axle 110, a fastener 130 holding the spool 120 on the axle 110, and a winding mechanism 140 mounted on the axle 110. The fishing reel assembly 100 is adapted for use without a casting rod. The assembly is used for fishing where the fisherman lands the fish by gripping the line directly. The assembly is particularly suited for ice fishing or other similar fishing techniques.

The support 101 includes a bracket that has a base plate 102 and an axle-support plate 103. Base plate 102 is mountable to a further part of the support, such as a tripod, a shanty, or other structure that positions the assembly 100 adjacent a fishing location. When used for ice fishing, the support 101 is positioned adjacent a hole in the ice. The base plate 102 is removably mountable, for example by fasteners, such as screws, bolts, nails, etc. in an embodiment. In a further embodiment, base plate 102 is fixed to a further structure, such as by welding, adhesives, pop rivets, etc. Other types of fasteners are within the scope of the present invention. The axle-support plate 103 extends outwardly from base plate 102. While described as plates, support elements 102 and 103 may include other types of support structures sufficient to support the other elements of the present invention.

Axle 110 is an elongate shaft having a support engaging end 111 that is fixed to support 101, for example, on plate 103. A first axle portion 112 adjacent end 111 is essentially smooth and rotatably supports spool 120. A fastener engaging, axle portion 113 is positioned adjacent portion 112 and remote from end 111. The fastener engaging, axle portion 113 receives a fastener 130 to hold the spool 120 on the portion 112. That is fastener 130 and portion 113 operate to longitudinally fix the spool 120 on the axle 110. In the illustrated embodiment, the portion 113 is threaded and the fastener 130 is a nut adapted to engage the threads. In a further embodiment, the spool supporting portion 112 has a reduced diameter relative to the fastener engaging portion 113. The fastener 130 can then slide along the axle beginning at end 111 and then be fixed to the portion 113. In a further embodiment, the axle 110 has a radially outwardly extension at axle portion 113 adjacent spool support, axle portion 112. This radial extension slidably contacts an outward face of the spool 120 to hold the spool on the axle. In an embodiment, end 111 includes a threaded portion that engages the support 101 and can be held in place with a nut. At the other end 114 of the axle 110, a key 115 extends radially outwardly. A further substantially smooth portion 116 is intermediate the fastener receiving portion and the key 115. Portion 116 supports the winding mechanism 140 in a longitudinally, relative to the axle 110, slidable manner. End 114 may further include a stop that prevents the winding mechanism 140 from being removed from the axle 110.

Spool 120 has a center core 122 that is cylindrical and is adapted to receive a winding of fishing line 150. Spool core 122 has a central journal bearing 123 therein. Journal bearing 123 receives portion 112 of the axle 110. Journal bearing 123 rotates on the axle portion 112 and allows the spool 120 to rotates in either direction (indicated by arrow 121) on axle portion 112. First and second spool ends 124, 125 are fixed to the core 122. Ends 124, 125, together with outer surface of the core 122 define a line receiving recess. Spool end 124 is positioned adjacent the support 101. In an embodiment, the spool end 124 has a disk shape with flat faces, which may slide on the plate 103. Spool end 125 includes a smooth surface facing inwardly into the line receiving recess and a latching mechanism 128. Latching mechanism 128 is operable to selectively latch the winding mechanism 140 to the spool 120. In the illustrated embodiment, the latch mechanism 128 includes a hub 129 fixed to spool core 122. Spokes 131 extend radially outwardly from the hub 129 to a outer wheel 133. A plurality of sidewardly open recesses 135 are defined by the hub 129, spokes 131 and wheel 133. The recesses 135 are open toward the winding mechanism 140 and remote from the line receiving recess. An inclined surface 137 is positioned in each recess 135. Surface 137 ends at and is essentially flush with a outward surface of one of the spokes 135 defining the recess in which the inclined surface is positioned. In an embodiment, the inclined surface 137 has its most recessed end adjacent a spoke 131 whereat the adjacent inclined surface 137 ends at the top of the spoke 131. The latching mechanism 128 thusly defines a ratchet to be engaged by a pawl defined by the winding mechanism as will be described in greater detail herein. The latching mechanism may further include opposed inclined surfaces that engage each other to hold the winding mechanism 140 and spool 120 together. For example, the surface 135 may be inclined outwardly and the engaging surface 149 of pawl 147 may matingly decline to hold the pawl on the spoke 131. In an embodiment, a ball and detent assembly is provided to hold the winding mechanism to the spool. In an embodiment, the latching mechanism 128 is a roller ratchet with the winding mechanism 140 acting on the driver and the spool end 125 being the follower.

Winding mechanism 140 includes a housing 142 through which extends a keyhole 144. Keyhole 144 operates as a journal bearing for the axle 110 such that the housing 142 is selectively rotatable and longitudinally slidable on the axle 110. Keyhole 144 further is shaped to selectively receive the key 115. When the key 115 is in keyhole 144, the winding mechanism 140 is not rotatable relative to the axle 110. A handle 145 extends outwardly and in parallel with the axle 110 from a side of housing 142 remote from the spool 120 and support 101. Handle 145 is engagable by a person to rotate the winding mechanism 140 on the axle 110. On the side of the housing facing the spool 120 is a protuberance or pawl 147. Pawl 147 is aligned with the recesses 135 in the spool end 125. Pawl 147 is selectively engagable in a recess 145. It will be recognized that a plurality of pawls 147 could be used with each aligned and engagable in a recess 135. Pawl 147 has an inclined face 148, which extends at a radius from the axle, and a face 149, which extends in the longitudinal direction of the axle. Face 149 is essentially flat in an embodiment. Face 149 contact the spoke 131 when the winding mechanism 140 is engaged with the spool 120. Inclined face 148 matches the incline surface 137 of the recesses 135 such that when the winding mechanism rotates in a line non-winding direction that inclined surface and face 137 and 148 allow the winding mechanism to rotate relative to the spool in that direction. When latched together, the winding mechanism 140 and spool 120 must rotate together in the line winding direction, which is opposite the non-winding direction.

Winding mechanism 140 further includes a motive force structure 160 adapted to rotate the spool 120. The motive force structure 160 can be a spring connected between the fixed axle 110 and the housing of the winding mechanism 140. In an embodiment, the spring is a torsion spring. In an embodiment, the spring is formed from a polymer to provide corrosion resistance and quiet operation. In an embodiment, the spring is formed from a metal such as stainless steel. The spring has its radially inward end 161 fixed to the axle 110 and radially outward end 162 fixed to the housing winding mechanism 140. The spring allows the winding mechanism 140 to move longitudinally on the axle 110, while maintaining its fixed ends on the axle and housing. In a further embodiment, the motive force structure 160 is a selectively actuated motor. The motor can be battery powered as a minor amount of power is needed to wind the fishing line 150 onto the spool 120. In an embodiment, the batteries are rated AA or AAA, LR3 in power. The motor may be powered by 1.5 volts or multiples thereof. The motive force structure 160 provides sufficient force to wind fishing line 150 onto spool 120 when the winding mechanism is in a winding position. However, the force is not sufficient to reel in a fish on its own. In an embodiment, the force is not sufficient to assist the fisherman in reeling in the fish. For example, the force applied by structure 160 is on the order of tenths of pounds. The force applied by structure 160 is up to about one pound. Accordingly, the fisherman must manually reel in or land the fish while the structure 160 winds the slacked fishing line only.

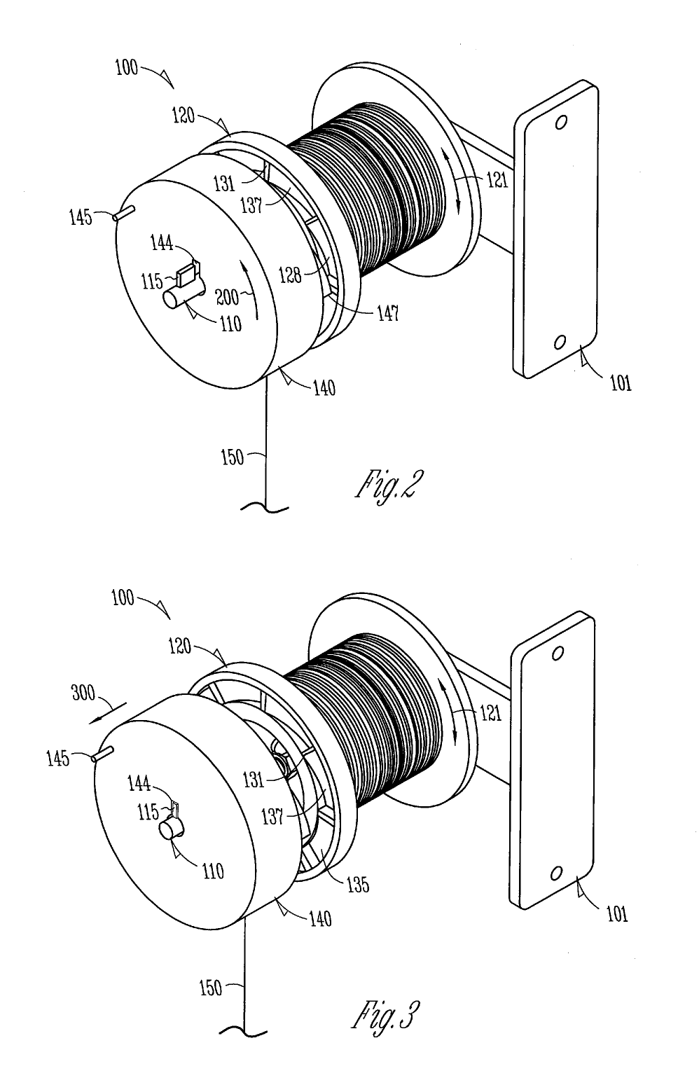

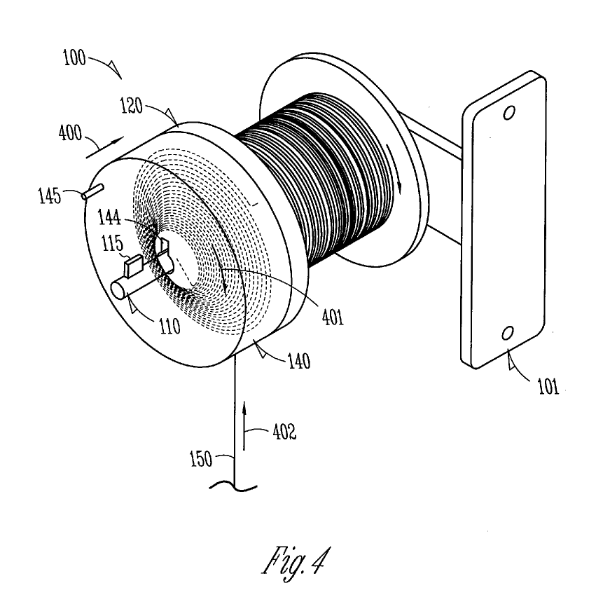

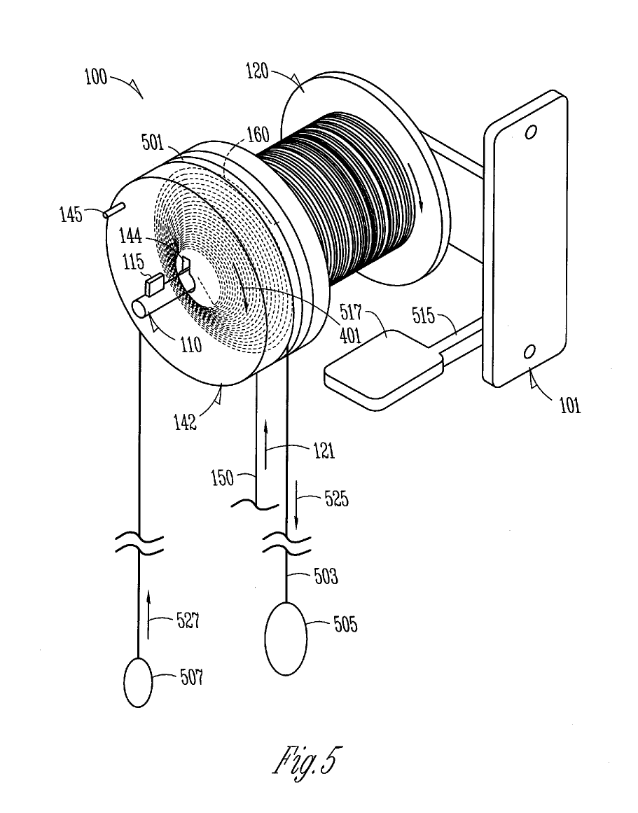

The winding mechanism 140 has at least three positions relative to the remainder of the assembly 100, i.e., spool 120 and axle 110. The first position is shown in FIG. 2 with the winding mechanism being rotatable relative to both the axle 110 and the spool 120. The second position is shown in FIG. 3 with the winding mechanism 140 fixed relative to the axle 110. Hence, the winding mechanism can not rotate about the axle. In the first and second positions, the spool 120 is freely rotatable on axle 110 and free from contact with the winding mechanism 140. The third position is shown in FIG. 4 with the winding mechanism 140 engaged to the spool 120 to automatically rotate spool 120 to wind the fishing line as will be explained in greater detail herein.

In operation, the fishing assembly 100 with fishing line 150 is positioned at a fishing location, such as a hole in the ice for ice fishing. The fisherman rotates the spool 120 to play out the line 150. Spool 120 is rotated counterclockwise as shown in FIGS. 2 and 3. FIG. 2 shows the first, loading position of the winding mechanism 140. As shown the pawl 147 is free from the ratchet structure 128. Thus, the winding mechanism 140 freely rotates relative to the spool 120. The shape of the pawl 147 and recess 135 further allow the winding mechanism 140 to rotate even if the pawl contacts the recess in one direction indicated by arrow 200. The winding mechanism 140 is loaded by rotating it in the counterclockwise direction as shown by arrow 200. The fisherman may rotate the winding mechanism by engaging handle 145. This may occur after the line is set. Rotating the winding mechanism 140 loads the spring-type motive force structure 160. That is, tension is placed on the spring 160. When tensioned the winding mechanism 140 is moved longitudinally on axle 110 toward axle end 114 to the second, storage position as shown in FIG. 3. The winding mechanism 140 moves in the direction shown by arrow 300 when moving from the first, winding position to the storage position. The key 115 is set in the keyhole 144 to prevent the winding mechanism 140 from rotating. The winding mechanism 140 is now stores the energy of the spring as it can not rotate on the axle 110.

When it is desired to reel in the line 150, the fisherman grips the line 150 intermediate the fishing location and the spool 120 and pulls the line in by hand. There is no handle fixed to the spool in an example. In the past, the line would pile on the ground, floor or ice as it is pulled in. After the line is pulled in, the fisherman would spin the spool 120 to return the line on spool 120. The assembly as described herein, provides a motive force that automatically spins the spool 120 to return the line 150 to the spool 120. The winding mechanism 140, which in the spring-type embodiment, is in the storage position. When the line is being pulled in by the fisherman, the winding mechanism 140 is moved to the third, winding position as shown in FIG. 4 in the direction shown by arrow 400. The pawl 147 is fixed against the spoke 131. The force of the structure 160 urges the spool 120 to rotate in the direction of arrow 401. In the spring embodiment, the tensioned spring has a first end fixed to the non-rotating axle 110 and a second end fixed to the rotatable housing 142. The housing 142 translates the force of the spring to the pawl 147. The pawl transmits the force to the spoke 131 and, hence, to the spool 120. The line is pulled upwardly in direction 402 as the fisherman pulls the line from the water. The force of the structure 160 is sufficient to wind fishing line 150 onto the spool 120. The force of the structure is not sufficient to land a fish.

In an embodiment of the present invention, the winding mechanism 140 operates similar to an automated window shade. Specifically, winding mechanism 140 holds in place when not activated and rotates the spool 120 under power of a spring, i.e., not under manual power, when activated. Examples of such structures can be found in U.S. Pat. Nos. 6,843,302; 6,666,252; 6,155,328; 5,697,122; 4,513,805; 4,172,563; 3,285,089; 219,747, each of which is incorporated by reference for any purpose. In operation, the winding mechanism is activated by pulling the line 150 to rotate the spool 120 a fraction of a turn whereat the spool 120 is released to rotate and is rotated by a motive force structure 160, such as a spring.

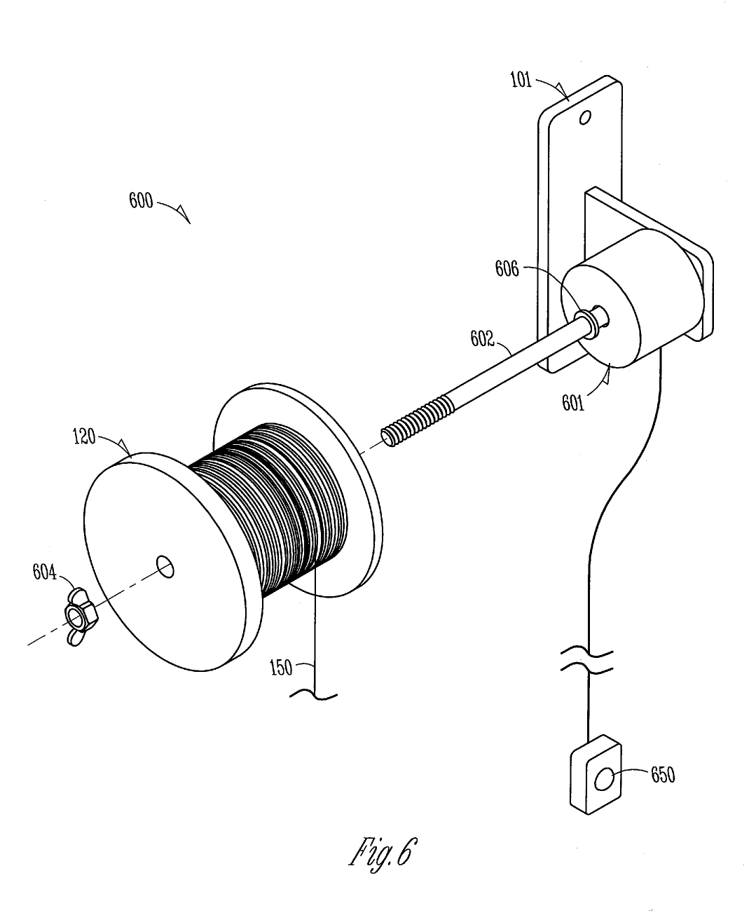

An embodiment of the present invention is shown in FIG. 5. Winding mechanism 140 includes an engagement groove 501 recessed into the outer circumference of the housing 142. A line or chain 503 is received in the groove 501. A first weight 505 is positioned at one end of the line 503. A second weight 509 is positioned at the other end of the line 503. The first weight 505 has a greater weight than the second weight 507. In an embodiment, the housing 142 is fixed against rotational movement by engaging key 115 as described above. In a further embodiment, the housing is always engaged with the spool 120. The first weight is supported by a support arm 515 that is fixed to the support 101. A weight placement or holder 517 holds the first weight 505 adjacent the housing and spool above the ground. In an embodiment, the placement 517 is laterally offset from the plumb line of the chain 503. The first weight 505 will provide the motive force to turn the spool and rewind the fishing line 150. When the first weight is positioned on the placement 517, there is no motive force to turn the housing and spool. In this embodiment, spring 160 is provided to act as a brake to retard the rotational motion of the spool. In a further embodiment, the spring 160 is absent. In operation, the fisherman engages the winding mechanism to the spool. The fisherman then removes the first weight 505 from the holder 517. In an embodiment, the fisherman engages the fishing line 150 with the winding mechanism engaged to the spool causes the winding mechanism and spool to turn counter clockwise with reference to FIG. 5. This causes the first weight 505 to fall off the placement 517. The first weight 505 will swing toward the winding mechanism 140 if the placement is positioned outwardly from the plumb line of the line 503. If the placement is positioned inwardly of the plumb of line 503, then the first weight will swing outwardly. In either case the first weight 505 will be free to fall and provide motive force to rotate the spool and rewind the fishing line. The first weight 505 starts to fall to the ground in the direction of arrow 525 away from the housing 142. The second weight 507 moves upwardly toward the housing 142 (arrow 527) and opposes the force imparted on the housing by the first weight. The first weight continues to fall and rotates the housing 142 and the spool 120 in the direction of arrow 401. The weight of each of the weights 505 and 507 are chosen to impart a force great enough to turn the spool and rewind the fishing line 150 but not enough to land a fish that is hooked on line 150. In a further embodiment, the housing has reduction gears so that the spool 120 will turn faster than the housing 142. This allows the spool to wind more fishing line than the weight 505 travels. In an embodiment, the gears are helical gears to reduce the noise.

FIG. 6 shows a further embodiment of the present invention and includes an assembly 600, which is similar to the assembly 100 as described herein. An electric motor 601 is fixed to support 101. The electric motor may be supplied with electrical power such as an AC or DC power source. The DC power source may be batteries as described herein or know in the electrical motor industry. The AC power source may be power supplied by a utility company such as a 50 or 60 Hz. Signal. An axle 602 is fixed to the motor 601. In an embodiment, the axle 602 is fixed to a rotor of the motor 601. The spool 120 with line 150 is fixed on the axle 602 for rotation by the motor. The spool may be fixed such that is freely rotates to play out the line 150 but is driven by the motor 601 to rotate and reel in slacked line 150. In the illustrated example, axle 602 includes a stop 606 adjacent the motor 601. Spool 120 slides onto the axles and is prevented from contacting the motor by the stop 606. A fastener 604 engages the axle 602 remote the motor and stop on another side of the spool 120 to hold the spool on the axle. In an example, the fastener is a nut and the axle includes threads to be engaged by the nut. Other fasteners such as kotter keys are contemplated. A control 650 is provided in communication with the motor 601. In an example, the control 650 communicates with motor 601 via a wire. In an example, the control 650 wirelessly communicates with motor 601. Control 650 selectively actuates motor 650 to rotate spool 120 to wind the line. The motor 650 can be battery powered as a relatively low amount of power is needed to wind the fishing line 150 onto the spool 120. In an embodiment, the batteries are rated AA or AAA, LR3 in power. The batteries can be loaded into control 650. In this example, a power signal is transmitted from control 650 through a wire to the motor 601. The motor may be powered by 1.5 volts or multiples thereof. The motor 601 provides sufficient force to wind fishing line 150 onto spool 120 when the winding mechanism is in a winding position. However, the force is not sufficient to reel in a fish. The fisherman supplies the force for reeling in a fish. For example, the force applied by motor 601 is on the order of tenths of pounds. The force applied by structure 601 is up to about one pound. Accordingly, the fisherman must manually reel in or land the fish while the structure 601 winds the slacked fishing line only.

The present assembly 100 may further include an indicator that notifies a fisherman that a fish may be on the line 150. Indicators include noise making devices and visual indicators. Noise making devices include rattles in the spool 120 or other noise making devices. Visual indicators include pop up flags or lights as known in the art. Examples of indicators can be found in U.S. Pat. Nos. 6,938,367; 6,935,068; 5,771,624; 5,101,591; and 5,040,323; all of which are hereby incorporated by reference for any purpose. These indicators are useable with embodiments of the present invention.

It is to be understood that the above description is intended to be illustrative, and not restrictive. For example, the above-described embodiments (and/or aspects thereof may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, various features may be grouped together to streamline the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus the following claims are hereby incorporated into the Detailed Description, with each claim standing on its own as a separate embodiment.

What is claimed is:

1. A rod-free fishing reel, comprising:
a rod-free spool assembly for holding fishing line; and
a winding mechanism having a first position engaged with the spool for rotating the spool to re-spool loose fishing line and a second position not in engagement with the spool.

2. The reel of claim 1, wherein the winding mechanism include a pawl to selectively engage the spool assembly.

3. The reel of claim 2, wherein the wherein the spool assembly includes a ratchet to receive the pawl.

4. The reel of claim 2, wherein the winding mechanism include a housing and the pawl is fixed to a side of the housing facing the spool assembly.

5. The reel of claim 1, wherein the winding mechanism include a motive force structure to rotate the spool assembly with the winding mechanism being in the second position.

6. The reel of claim 5, wherein the winding mechanism rotates with the spool assembly in the second position.

7. The reel of claim 5, wherein the motive force structure is a coil spring.

8. The reel of claim 5, wherein the motive force structure is an electric motor.

9. The reel of claim 1, wherein the winding mechanism provides a rotational force to the spool sufficient to wind fishing line and insufficient to reel in a fish.

10. A rodless fishing reel system, comprising:
a support;
an axle having a first end fixed to the support;
a spool on the axle, the spool being rotatable on the axle;
a winding mechanism on the axle, the winding mechanism having a first position that is rotatable on the axle, a second position that is fixed on the axle and a third position that is engaged with the spool and rotatable on the axle.

11. The fishing reel system of claim 10, wherein the winding mechanism includes a motive force structure that is loadable in the first position, stores force in the second position, and transmits force to the spool in the third position.

12. The fishing reel system of claim 11, wherein the winding mechanism includes a housing and a spring that has a first end fixed to the axle and a second end fixed to the housing, and wherein the spring is loadable with a force in the first position.

13. The fishing reel system of claim 12, wherein the axle includes a key, and wherein the housing engages the key in the second position to prevent the spring from releasing a stored force.

14. The fishing reel system of claim 13, wherein the spool includes ratchet, and wherein the housing includes a pawl that engages the ratchet in the third position.

15. The fishing reel system of claim 13, wherein the housing includes a keyhole that journals the axle and receives the key.

16. The fishing reel system of claim 10, wherein the housing includes a handle on a side remote from the spool.

17. The fishing reel system of claim 10, wherein the axle includes a fastener that holds the spool at a fixed longitudinal position.

18. The fishing reel system of claim 10, wherein the winding mechanism includes an electric motor to selectively rotate the spool.

19. The fishing reel system of claim 10, wherein the spool stores fishing line and supplies fishing line to a fishing hole free of other line holding devices.

20. The fishing reel system of claim 10, wherein the support includes an attachment to at least one of a shanty, a tripod, and a ground/ice contacting base.
